(19) United States
(12) Patent Application Publication
(10) Pub. No.: US 2014/0169387 A1
(43) Pub. Date: Jun. 19, 2014

(54) METHOD AND COMMUNICATION APPARATUS FOR TRANSMITTING GROUP FRAME, AND METHOD AND USER TERMINAL FOR RECEIVING GROUP FRAME

(71) Applicant: Electronics and Telecommunications Research Institute, Daejeon (KR)

(72) Inventors: Kyeong Pyo KIM, Daejeon (KR); Hyoung Jin KWON, Cheongju (KR); Min Ho CHEONG, Daejeon (KR); Jae Seung LEE, Daejeon (KR); Sok Kyu LEE, Daejeon (KR)

(73) Assignee: Electronics and Telecommunications Research Institute, Daejeon (KR)

(21) Appl. No.: 14/105,093

(22) Filed: Dec. 12, 2013

(30) Foreign Application Priority Data
Dec. 14, 2012 (KR) 10-2012-0146578
Dec. 2, 2013 (KR) 10-2013-0148542

(51) Int. Cl. H04L 29/06

(52) U.S. Cl. CPC H04L 69/22
USPC 370/473

(57) ABSTRACT

A communication apparatus and method for transmitting a group frame, and a user terminal and method for receiving a group frame are provided. The communication apparatus may transmit a group frame to each of a plurality of user terminals. The group frame may be generated by grouping, in a physical layer, frames that are respectively transmitted to the plurality of user terminals.

### CROSS-REFERENCE TO RELATED APPLICATIONS

This application claims the benefit of Korean Patent Application No. 10-2012-0146578 and of Korean Patent Application No. 10-2013-0148542, respectively filed on Dec. 14, 2012 and Dec. 2, 2013, in the Korean Intellectual Property Office, the disclosures of which are incorporated herein by reference.

### BACKGROUND

1. Field of the Invention

The present invention relates to a method and apparatus for forming a single group frame by grouping frames that are respectively transmitted to a plurality of user terminals in a physical layer, to more effectively transmit the frames to the plurality of user terminals.

2. Description of the Related Art

A conventional frame transmission technology for multiple users in a physical layer is used to transmit data for each of the users, for each stream. However, there is a limitation on transmission of data for each stream, since multiple antennas are required. A number of the multiple antennas may be equal to or greater than a number of the multiple users.

A conventional group frame transmission technology for multiple users in a media access control (MAC) is used to transmit a group frame to multiple users. However, there is a limitation that a group frame needs to be formed based on a user with a lowest data transmission rate among users communicating with a communication apparatus, when a data transmission rate needs to be determined for each frame due to different channel environments or different data applications for each of the users.

Accordingly, there is a desire for a technology for transmitting frames for multiple users, regardless of a number of antennas, and for transmitting a group frame based on an optimum data transmission rate for each user, despite different channel environments or different applications.

### SUMMARY

An aspect of the present invention provides a method and apparatus for generating a group frame by grouping, in a physical layer, frames respectively transmitted to a plurality of user terminals included in a single group, and for omitting a part of a preamble that is transmitted to all of the plurality of user terminals when the frames are respectively transmitted to the plurality of user terminals, to reduce data transmission resources and to increase a data throughput.

Another aspect of the present invention provides a method and apparatus for transmitting a group frame to a plurality of user terminals, regardless of a number of antennas.

Still another aspect of the present invention provides a method and apparatus for transmitting a group frame based on an optimum data transmission rate for each of a plurality of user terminals, despite different channel environments or different applications, since a data transmission rate is controlled for each user when the group frame is formed in a physical layer.

According to an aspect of the present invention, there is provided a communication apparatus, including: a generator to generate a group frame by grouping frames in a physical layer, the frames being respectively transmitted to a plurality of user terminals included in a single group; and a transmitter to transmit the group frame to each of the plurality of user terminals, wherein the group frame includes a first data field applied to all of the plurality of user terminals, and a second data field applied to each of the plurality of user terminals.

The first data field may include group information including at least one of identification information indicating whether a received frame is the group frame, a number of the plurality of user terminals included in the group, and length information of the group frame, and user information including at least one of length information and a modulation and coding scheme (MCS) of original data of each of the plurality of user terminals.

The group information may be arranged in an order of original data included in the second data field.

The second data field may include control information regarding a transmission channel of the group frame for each of the plurality of user terminals, and original data that is to be transmitted to each of the plurality of user terminals.

Control information associated with a user device corresponding to first transmitted original data among original data included in the group frame may be excluded from the second data field.

According to another aspect of the present invention, there is provided a user terminal, including: a receiver to receive a group frame from a communication apparatus, the group frame being generated by grouping frames in a physical layer, the frames being respectively transmitted to a plurality of user terminals included in a single group; and a communication unit to communicate with the communication apparatus using the group frame, wherein the group frame includes a first data field applied to all of the plurality of user terminals, and a second data field applied to each of the plurality of user terminals.

The first data field may include group information including at least one of identification information indicating whether a received frame is the group frame, a number of the plurality of user terminals included in the group, and length information of the group frame, and user information including at least one of length information and an MCS of original data of each of the plurality of user terminals.

The second data field may include control information regarding a transmission channel of the group frame for each of the plurality of user terminals, and original data that is to be transmitted to each of the plurality of user terminals.

Control information associated with a user device corresponding to first transmitted original data among original data included in the group frame may be excluded from the second data field.

The receiver may receive the first data field, and may resume receiving of the second data field after interruption of receiving for a period of time based on user information of another user terminal included in the first data field.

According to another aspect of the present invention, there is provided a method of transmitting a group frame, the method including: generating a group frame by grouping frames in a physical layer, the frames being respectively transmitted to a plurality of user terminals included in a single group; and transmitting the group frame to each of the plurality of user terminals, wherein the group frame includes a first data field applied to all of the plurality of user terminals, and a second data field applied to each of the plurality of user terminals.

The first data field may include group information including at least one of identification information indicating whether a received frame is the group frame, a number of the plurality of user terminals included in the group, and length information of the group frame, and user information including at least one of length information and an MCS of original data of each of the plurality of user terminals.

The group information may be arranged in an order of original data included in the second data field.

The second data field may include control information regarding a transmission channel of the group frame for each of the plurality of user terminals, and original data that is to be transmitted to each of the plurality of user terminals.

Control information associated with a user device corresponding to first transmitted original data among original data included in the group frame may be excluded from the second data field.

According to another aspect of the present invention, there is provided a method of receiving a group frame, the method including: receiving a group frame from a communication apparatus, the group frame being generated by grouping frames in a physical layer, the frames being respectively transmitted to a plurality of user terminals included in a single group; and communicating with the communication apparatus using the group frame, wherein the group frame includes a first data field applied to all of the plurality of user terminals, and a second data field applied to each of the plurality of user terminals.

The first data field may include group information including at least one of identification information indicating whether a received frame is the group frame, a number of the plurality of user terminals included in the group, and length information of the group frame, and user information including at least one of length information and an MCS of original data of each of the plurality of user terminals.

The second data field may include control information regarding a transmission channel of the group frame for each of the plurality of user terminals, and original data that is to be transmitted to each of the plurality of user terminals.

Control information associated with a user device corresponding to first transmitted original data among original data included in the group frame may be excluded from the second data field.

The receiving may include receiving the first data field, and resuming receiving of the second data field after interruption of receiving for a period of time based on user information of another user terminal included in the first data field.

### Effect

According to embodiments of the present invention, a group frame may be generated by grouping, in a physical layer, frames respectively transmitted to a plurality of user terminals included in a single group, and a part of a preamble that is transmitted to all of the plurality of user terminals may be omitted when the frames are respectively transmitted to the plurality of user terminals and thus, it is possible to reduce data transmission resources and to increase a data throughput.

Additionally, according to embodiments of the present invention, it is possible to transmit a group frame to a plurality of user terminals, regardless of a number of antennas.

Moreover, according to embodiments of the present invention, it is possible to transmit a group frame based on an optimum data transmission rate for each of a plurality of user terminals, despite different channel environments or different applications, since a data transmission rate is controlled for each user, when the group frame is formed in a physical layer.

Furthermore, according to embodiments of the present invention, a user terminal may interrupt receiving of data before receiving data for the user terminal, and may resume the receiving from a position of original data the user terminal desires to receive and thus, it is possible to minimize power consumption.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a communication apparatus, and user terminals included in a single group according to an embodiment;

FIG. 2 is a diagram illustrating a group frame according to an embodiment;

FIG. 3 is a flowchart illustrating a method of receiving a group frame according to an embodiment;

FIG. 4 is a diagram illustrating group frames received by a plurality of user terminals according to an embodiment;

FIGS. 5 through 7 are diagrams illustrating frames according to an embodiment; and

FIGS. 8 through 12 are diagrams illustrating frames according to another embodiment.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

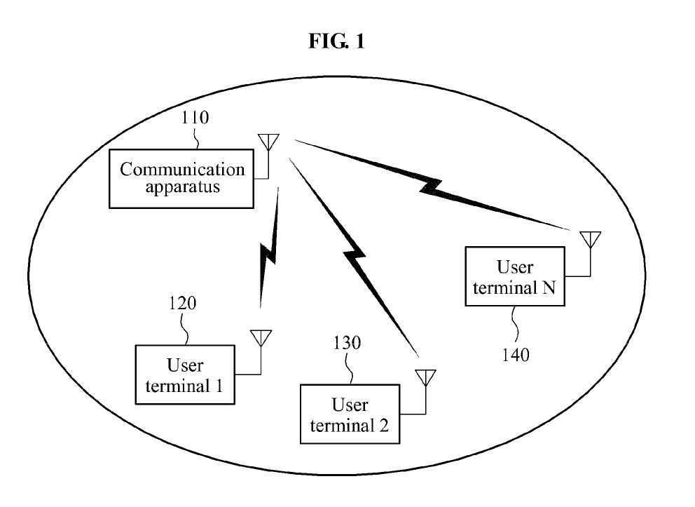

FIG. 1 is a diagram illustrating a communication apparatus 110, and user terminals 120 to 140 included in a single group according to an embodiment.

Referring to FIG. 1, the communication apparatus 110 may transmit a frame to each of a plurality of user terminals, for example, the user terminals 120 to 140. The user terminals 120 to 140 may have the same group ID. The user terminals 120 to 140 may be different from each other in at least one of a communication environment, a data application and a distance with the communication apparatus 110. Accordingly, the communication apparatus 110 may need to transmit frames with different data transmission rates and different lengths to the user terminals 120 to 140, respectively.

When preambles applied to all of the user terminals 120 to 140 are grouped and transmitted to the user terminals 120 to 140, the communication apparatus 110 may transmit only a single frame to the user terminals 120 to 140. In other words, the communication apparatus 110 may transmit a group frame to each of the user terminals 120 to 140, and may perform communication. The group frame may be generated by grouping frames transmitted to the user terminals 120 to 140, in a physical layer.

The communication apparatus 110 may communicate with the plurality of user terminals, and may include, for example, a base station, an access point (AP), and the like.

The communication apparatus 110 may reduce a data transmission resource, and may increase a data throughput, by omitting a part of a preamble that is transmitted to all of the plurality of user terminals, when frames are respectively transmitted to the plurality of user terminals through the group frame.

Additionally, the communication apparatus 110 may use a single group frame, to transmit frames to the plurality of user terminals, regardless of a number of antennas.

Furthermore, the communication apparatus 110 may form a group frame in a physical layer, and may control a data transmission rate for each user terminal. Accordingly, an optimum data transmission rate may be used for each of a plurality of user terminals, despite different channel environments or different applications.

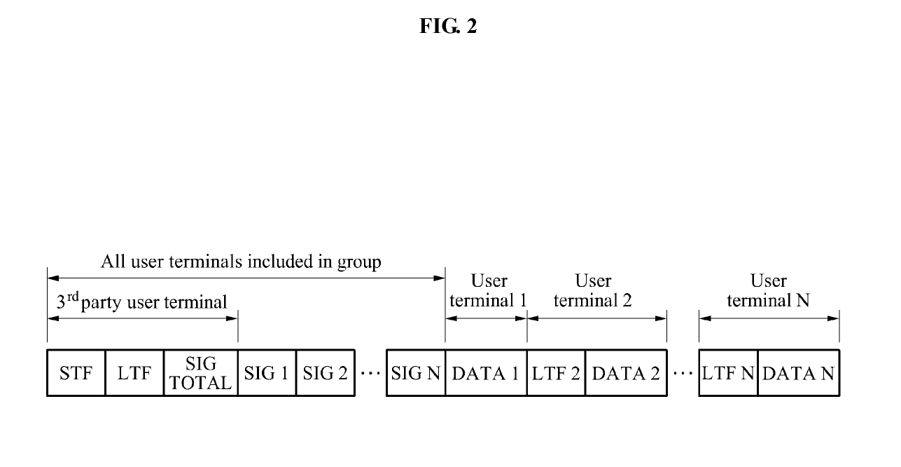

FIG. 2 is a diagram illustrating a group frame according to an embodiment.

Referring to FIG. 2, the group frame may include a first data field applied to all of a plurality of user terminals, and a second data field applied to each of the plurality of user terminals.

The first data field may refer to a data field received by all of a plurality of user terminals included in a single group. Additionally, the second data field may refer to a data field including different data received by each of the plurality of user terminals.

The first data field may include group information and user information.

The group information may include a data transmission rate and length information of each of original data that are grouped. For example, the group information may include information of a group frame, instead of information of each of the plurality of user terminals. The group information may have the same configuration as a special interest group (SIG) field in a typical frame. Accordingly, a SIG TOTAL field may be compatible with a SIG field of an existing frame. The group information may correspond to a SIG TOTAL field of FIG. 2. Hereinafter, the group information will be described as a SIG TOTAL field.

A SIG TOTAL field according to an embodiment of the present invention may further include three types of information below.

The SIG TOTAL field may include identification information indicating whether a received frame is a group frame. The received frame may refer to a frame received by a user terminal from a communication apparatus. For example, when the received frame is determined to be the group frame, the identification information may include a group ID.

The identification information may be included in at least one of reserved bits in a typical SIG field. For example, when a user terminal does not use a group frame, or does not have the same group ID as a group ID of the group frame, the user terminal may skip receiving of remaining parts of the group frame.

Additionally, the SIG TOTAL field may include a number of user terminals included in a group. The SIG TOTAL field may include a number of user terminals with the same group ID as a group ID of a group frame. For example, a number of user terminals included in a single group may be included in an unused bit among bits of an interest group field of a typical frame.

Furthermore, the SIG TOTAL field may include length information of a group frame. The length information may include overall length information and partial length information of the group frame.

In an example, the overall length information may be calculated based on a modulation and coding scheme (MCS) of each of a plurality of user terminals in a group, original data length information, and a long training field (LTF) between original data of the plurality of user terminals. In another example, the overall length information may be replaced by information regarding a total time of the group frame.

The user information may include at least one of length information and an MCS of original data each of the plurality of user terminals desires to receive.

The user information may correspond to a SIG 1 field to a SIG N field of FIG. 2, and may be referred to as “user-specific SIG.” The SIG 1 field may include length information and an MCS of original data a user terminal 1 desires to receive, and the SIG N field may include length information and an MCS of original data a user terminal N desires to receive. Hereinafter, the user information will be described as a user-specific SIG field.

For example, the user-specific SIG field may be formed by grouping at least one SIG field including length information and an MCS of original data of each of a plurality of user terminals. The user-specific SIG field may be located in a front portion of a group frame. Accordingly, a user terminal may receive desired original data, even when original data another user terminal desires to receive is lost in the group frame.

User-specific SIG fields may be arranged in an order of original data included in a group frame.

Additionally, a user terminal may determine where original data the user terminal desires to receive is located in a group frame, based on a user-specific SIG field of the user terminal.

As described above, the communication apparatus may transmit a group frame based on an optimum data transmission rate for each of user terminals with different channel environments or different applications, by controlling a data transmission rate for each of the user terminals, through a user-specific SIG field.

The second data field may include control information regarding a transmission channel of a group frame for each of a plurality of user terminals, and original data that is to be transmitted to each of the plurality of user terminals.

The control information may be used to predict a fine frequency error and channel between a corresponding user terminal and the communication apparatus. For example, the control information may correspond to an LTF 2 to an LTF N of FIG. 2.

In an example, control information associated with a user terminal corresponding to first transmitted original data among original data included in a group frame may be excluded from the second data field. For example, control information of the user terminal 1, that is, an LTF 1 may be excluded.

As a number of user terminals increases, an overall length of a frame may increases. Accordingly, an error may occur in tracking of a phase, a carrier frequency, or a sampling frequency, or a communication channel state may be changed. A user terminal may accurately receive desired original data using an LTF.

Additionally, an original data loss possibility may increase in proportion to a length of a group frame. When original data is partially lost, a user terminal after to a user terminal corresponding to the lost original data may receive desired original data based on control information. For example, when a DATA 2 field is lost, a user terminal 3 may receive a DATA 3 field based on control information, that is, an LTF 3.

In another example, an LTF of a group frame may be used as control information without a change, or a transformed LTF, for example an LTF with a reduced length, and the like, may be used as control information.

The original data may be transmitted, based on a communication environment, a data transmission rate, and an MCS in association with a corresponding user terminal. In other words, a scheme of transmitting original data may be determined based on a user terminal. The original data may be identified by the control information.

The original data may correspond to a DATA 1 field to a DATA N field of FIG. 2. The DATA 1 field may include original data the user terminal 1 desires to receive, and the DATA 2 field may include original data a user terminal 2 desires to receive, and the DATA N field may include original data the user terminal N desires to receive.

The group frame may include a short training field (STF), and an LTF.

In the group frame, the STF and the LTF may be located in front of the other fields. Additionally, the STF and the LTF may be identical to an STF and an LTF included in a typical frame. The STF may include information used to approximately synchronize a communication apparatus with a user terminal. The LTF may include information used to predict a channel and to finely synchronize the communication apparatus with the user terminal.

For example, the STF and the LTF may be transmitted to all of the plurality of user terminals. Accordingly, the STF and the LTF may refer to common fields.

A 3^{rd} party user terminal may be a user terminal that is not included in a group. The 3^{rd} party user terminal may include, for example, a user terminal that may not use a group frame, or a user terminal that may not have the same group ID as the group frame. The 3^{rd} party user terminal may receive an STF, an LTF, and a SIG TOTAL field, and may interrupt the receiving.

All user terminals included in a group may receive an STF, an LTF, a SIG TOTAL field, and a user-specific SIG field. For example, each of the user terminals may receive an group frame from an STF to a user-specific SIG field in association with each of the user terminals.

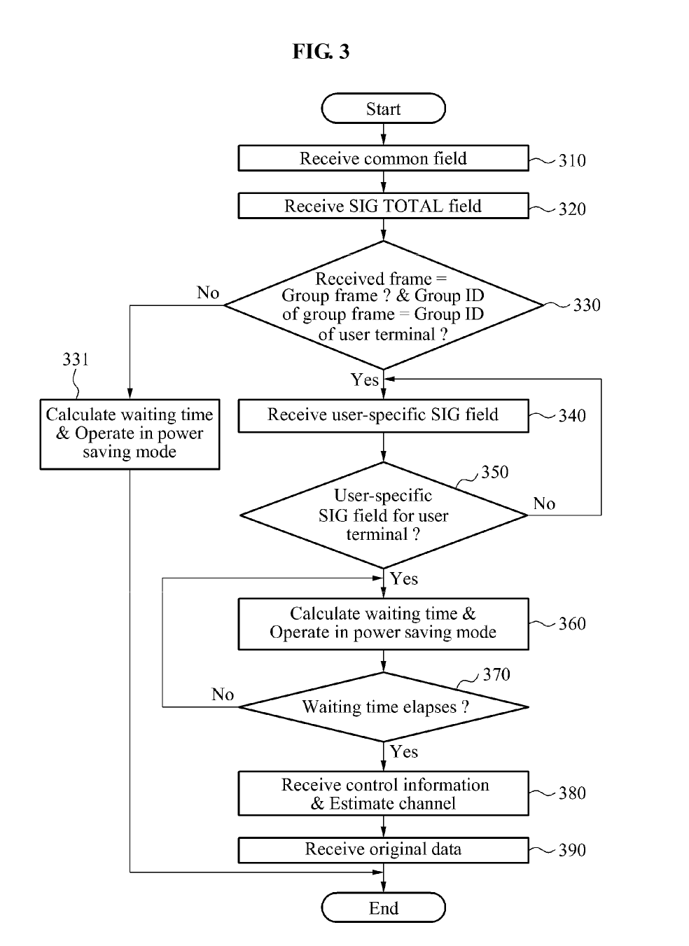

FIG. 3 is a flowchart illustrating a method of receiving a group frame according to an embodiment.

The method of FIG. 3 may be performed by a processor included in a user terminal.

Referring to FIG. 3, in operation 310, the user terminal may receive a common field. The common field may include an STF and an LTF that are located in a front portion of a group frame.

In operation 320, the user terminal may receive a SIG TOTAL field. The SIG TOTAL field may include information regarding a format of the group frame. The SIG TOTAL field may include at least one of identification information indicating whether a received frame is a group frame, a number of user terminals in a group, and length information of the group frame.

In operation 330, the user terminal may determine whether a received frame is the group frame, based on the SIG TOTAL field. When the received frame is determined to be the group frame, the user terminal may determine whether a group ID of the group frame is identical to a group ID of the user terminal in operation 330.

When the group ID of the group frame is different from the group ID of the user terminal, the user terminal may calculate a waiting time in operation 331. The user terminal may calculate the waiting time, based on overall length information of the group frame that is included in the SIG TOTAL field. When the waiting time is calculated, the user terminal may operate in a power saving mode during the waiting time. The waiting time may refer to a period of time during which the user terminal waits to receive the group frame again after interrupting receiving of the group frame.

When the group ID of the group frame is identical to the group ID of the user terminal, the user terminal may continue to receive the group frame in operation 340. In operation 340, the user terminal may receive a user-specific SIG field.

In operation 350, the user terminal may determine whether the received user-specific SIG field corresponds to the user terminal. When the received user-specific SIG field does not correspond to the user terminal, the user terminal may continue to receive another user-specific SIG field. For example, the user terminal may receive a user-specific SIG field, until a user-specific SIG field for the user terminal is received. Accordingly, the user terminal may determine an order in which original data the user terminal desires to receive is located in the group frame.

When the received user-specific SIG field corresponds to the user terminal, the user terminal may calculate a waiting time, and may operate in the power saving mode in operation 360.

For example, the user terminal may calculate a reception resumption time, based on a user-specific SIG field for another user terminal that is received earlier than the user-specific SIG field for the user terminal The user terminal may calculate the waiting time, based on length information and an MCS included in the user-specific SIG field for the other user terminal.

Additionally, the user terminal may calculate the waiting time, based on a number of user terminals included in a group, and the order in which the original data the user terminal desires to receive is located in the group frame.

When the waiting time is calculated, the user terminal may operate in the power saving mode.

In operation 370, the user terminal may determine whether the waiting time elapses.

When the waiting time does not elapse, the user terminal may continuously operate in the power saving mode. In other words, during the waiting time, the user terminal may operate in the power saving mode. For example, when a user-specific SIG field for each of a plurality of user terminals is received, each of the plurality of user terminals may operate in the power saving mode.

When the waiting time elapses, the user terminal may receive control information, and may estimate a channel in operation 380. For example, the user terminal may estimate a channel state, based on received control information when the waiting time elapses.

In operation 390, the user terminal may receive desired original data, through the estimated channel.

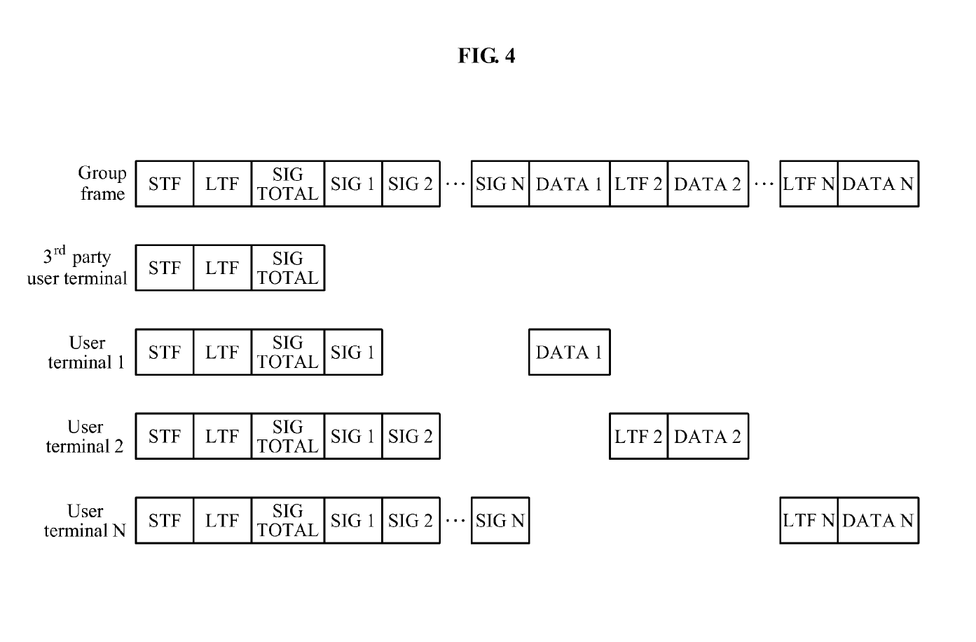

FIG. 4 is a diagram illustrating group frames received by a plurality of user terminals according to an embodiment.

FIG. 4 illustrates actual group frames that are received by a plurality of user terminals, for example, a 3^{rd} party user terminal, a user terminal 1, a user terminal 2, and a user terminal N.

The 3^{rd} party user terminal may refer to a user terminal that is incapable of receiving a group frame or that does not have the same group ID as the group frame. In other words, the 3^{rd} party user terminal may refer to a user terminal that is not included in a group.

When a SIG TOTAL field is received, the 3^{rd} party user terminal may calculate a waiting time, and may operate in a power saving mode. The 3^{rd} party user terminal may calculate the waiting time, based on the SIG TOTAL field. The waiting time of the 3^{rd} party user terminal may refer to a period of time during which user information and a second data field are transmitted. Accordingly, the 3^{rd} party user terminal may receive an STF, an LTF, and the SIG TOTAL field.

The user terminal 1 may be, for example, a user terminal that has the same group ID as the group frame and that desires to receive original data located in a first position among original data included in the group frame. The user terminal 1 may receive user-specific SIG field associated with the user terminal 1, that is, a SIG 1 field, may calculate a waiting time, and may operate in the power saving mode. The user terminal 1 may calculate the waiting time, based on a SIG TOTAL field and the SIG 1 field. The waiting time of the user terminal 1 may refer to a period of time during which user information and a second data field between the SIG 1 field and a DATA 1 field are transmitted.

The user terminal 1 may resume receiving of the group frame after the waiting time, and may receive the DATA 1 field. In other words, the user terminal 1 may receive an STF, an LTF, the SIG TOTAL field, the SIG 1 field, and the DATA 1 field.

The user terminal 2 may be, for example, a user terminal that has the same group ID as the group frame and that desires to receive original data located in a second position among the original data included in the group frame. The user terminal 2 may receive a user-specific SIG field associated with the user terminal 2, that is, a SIG 2 field, may calculate a waiting time, and may operate in the power saving mode. The user terminal 2 may calculate the waiting time, based on a SIG TOTAL field, a SIG 1 field, and the SIG 2 field. The waiting time of the user terminal 2 may refer to a period of time during which user information and a second data field between the SIG 2 field and an LTF 2 are transmitted.

The user terminal 2 may resume receiving of the group frame after the waiting time, and may receive a DATA 2 field, and control information associated with the user terminal 2, that is, the LTF 2. In other words, the user terminal 2 may receive an STF, an LTF, the SIG TOTAL field, the SIG 1 field, the SIG 2 field, the LTF 2, and the DATA 2 field.

The user terminal N may be, for example, a user terminal that has the same group ID as the group frame and that desires to receive original data located in an N^{th} position among the original data included in the group frame. The user terminal N may receive a user-specific SIG field associated with the user terminal N, that is, a SIG N field, may calculate a waiting time, and may operate in the power saving mode. The user terminal N may calculate the waiting time, based on a SIG TOTAL field and a SIG 1 field to the SIG N field. The waiting time of the user terminal N may refer to a period of time during which a second data field between the SIG N field and an LTF N are transmitted.

The user terminal N may resume receiving of the group frame after the waiting time, and may receive a DATA N field, and control information associated with the user terminal N, that is, the LTF N. In other words, the user terminal N may receive an STF, an LTF, the SIG TOTAL field, the LTF N, the DATA N field, and the SIG 1 field to the SIG N field.

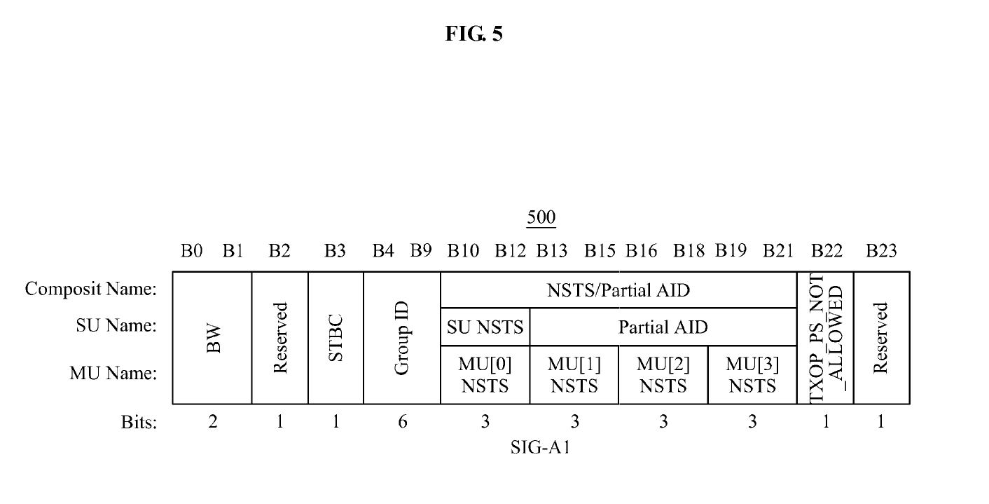

FIGS. 5 through 7 are diagrams illustrating frames according to an embodiment.

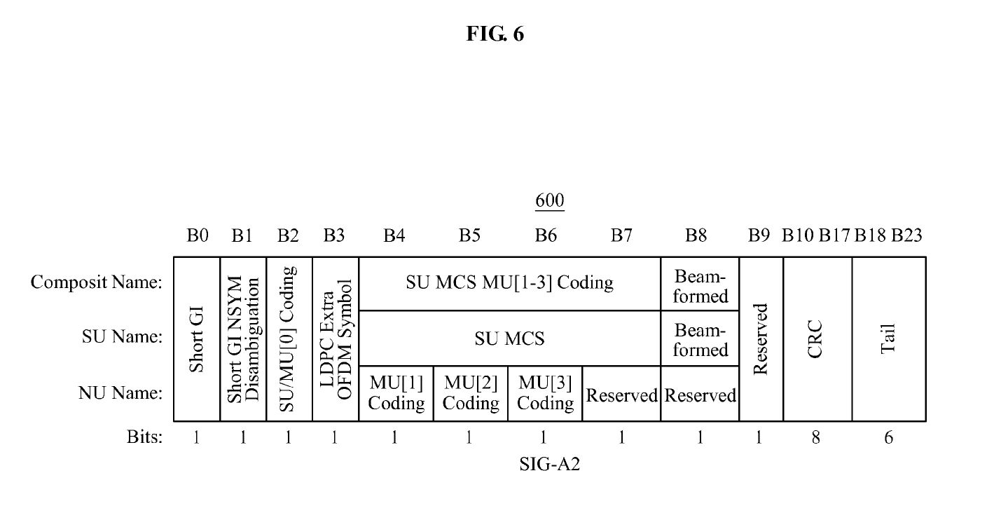

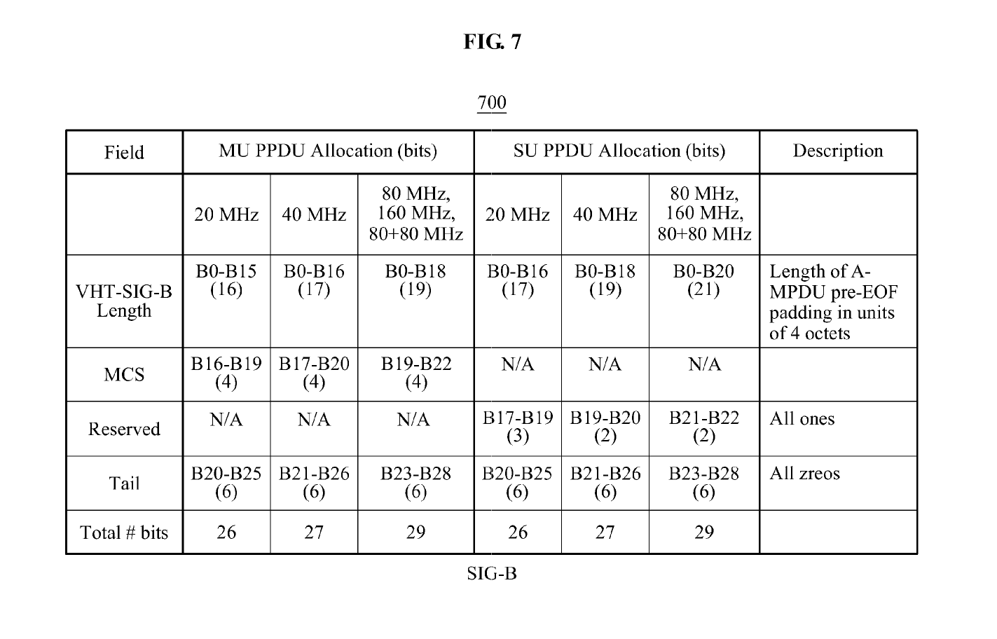

FIG. 5 illustrates a frame 500 of SIG-A1 according to an embodiment. FIG. 6 illustrates a frame 600 of SIG-A2 according to an embodiment. FIG. 7 illustrates a frame 700 of SIG-B according to an embodiment.

For example, at least one bit among reserved bits of each of the frames 500 to 700 may include identification information indicating whether a frame transmitted to each of a plurality of user terminals is a group frame.

Additionally, an MCS field or a tail field of each of the frames 500 to 700 may include a number of user terminals included in a group. The MCS field or the tail field may include unnecessary information in a SIG TOTAL field based on a value of a bit including identification information indicating whether a frame transmitted to each of the plurality of user terminals is a group frame.

In other words, a bit including the unnecessary information may include the number of the user terminals. Additionally, the bit including the unnecessary information may include overall length information of the group frame.

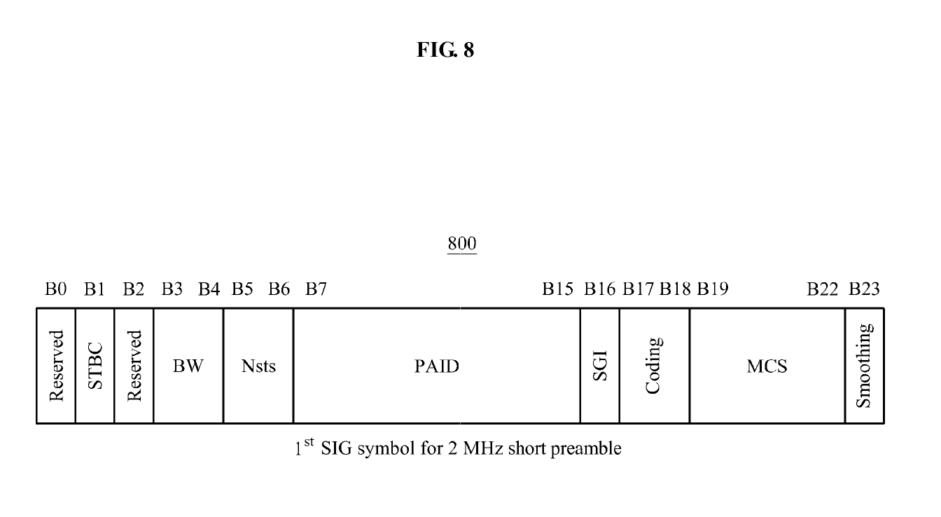

FIGS. 8 through 12 are diagrams illustrating frames according to another embodiment.

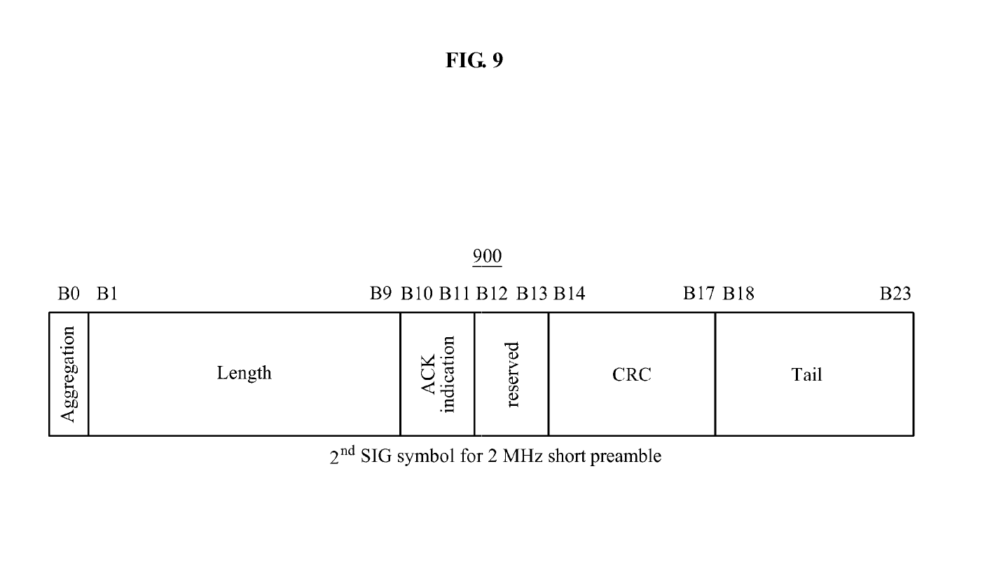

FIGS. 8 and 9 illustrate frames 800 and 900 for a 2 MHz short preamble, respectively. For example, a bit B0 of a 1^{st} symbol of the frame 800, or bits B12 and B13 of a 2^{nd} symbol of the frame 900 may include identification information indicating whether a frame transmitted to each of a plurality of user terminals is a group frame.

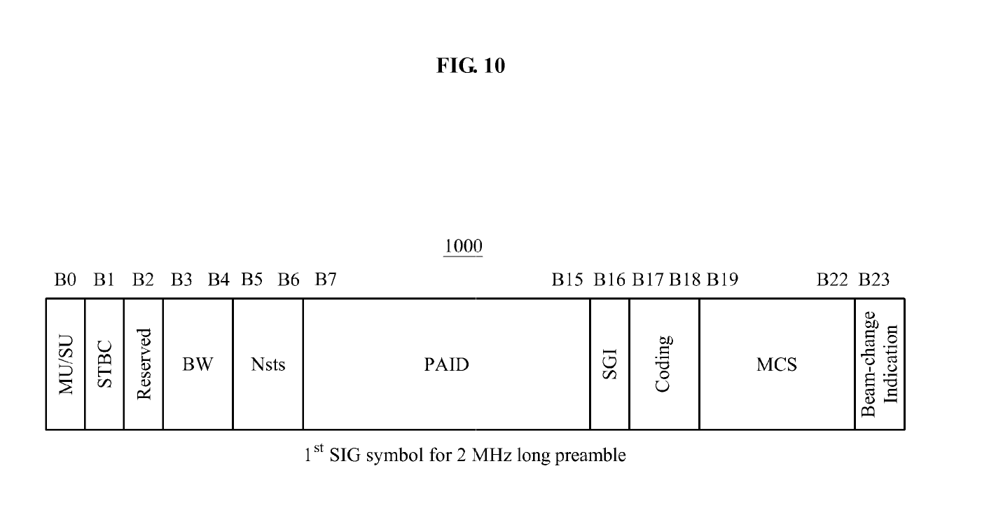

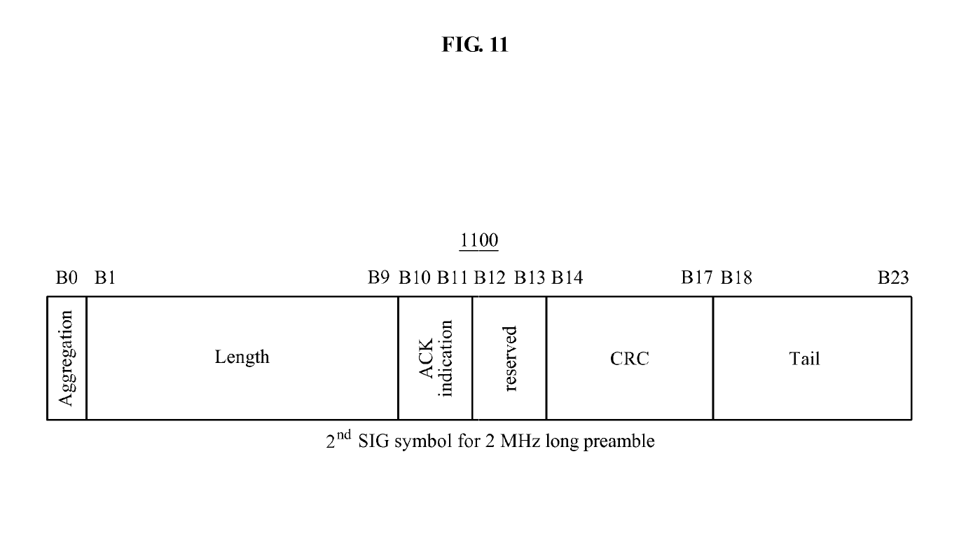

FIGS. 10 and 11 illustrate frames 1000 and 1100 for a 2 MHz long preamble, respectively. For example, a bit B2 of a 1^{st} symbol of the frame 1000, or bits B12 and B13 of a 2^{nd} symbol of the frame 1100 may include identification information indicating whether a frame transmitted to each of a plurality of user terminals is a group frame.

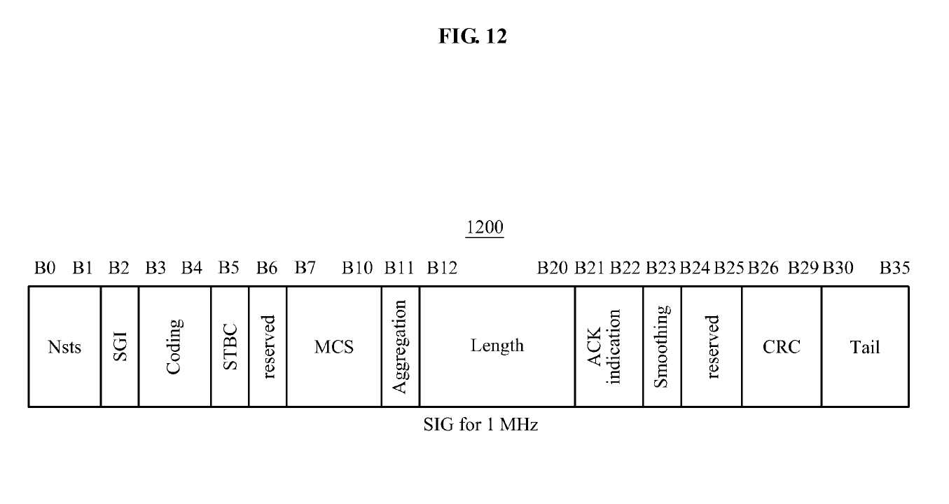

FIG. 12 illustrates a frame 1200 of 1 MHz. For example, bits B24 and B25 of the frame 1200 may include identification information indicating whether a frame transmitted to each of a plurality of user terminals is a group frame.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments that accomplish the examples disclosed herein can be easily construed by programmers skilled in the art to which the examples pertain based on and using the flow diagrams and block diagrams of the figures and their corresponding descriptions as provided herein.

As a non-exhaustive illustration only, a terminal or device described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication apparatus, comprising:
a generator to generate a group frame by grouping frames in a physical layer, the frames being respectively transmitted to a plurality of user terminals included in a single group; and
a transmitter to transmit the group frame to each of the plurality of user terminals,
wherein the group frame comprises a first data field applied to all of the plurality of user terminals, and a second data field applied to each of the plurality of user terminals.

2. The communication apparatus of claim 1, wherein the first data field comprises:
group information comprising at least one of identification information indicating whether a received frame is the group frame, a number of the plurality of user terminals included in the group, and length information of the group frame; and
user information comprising at least one of length information and a modulation and coding scheme (MCS) of original data of each of the plurality of user terminals.

3. The communication apparatus of claim 2, wherein the group information is arranged in an order of original data included in the second data field.

4. The communication apparatus of claim 1, wherein the second data field comprises:
control information regarding a transmission channel of the group frame for each of the plurality of user terminals; and
original data to be transmitted to each of the plurality of user terminals.

5. The communication apparatus of claim 1, wherein control information associated with a user device corresponding to first transmitted original data among original data included in the group frame is excluded from the second data field.

6. A user terminal, comprising:
a receiver to receive a group frame from a communication apparatus, the group frame being generated by grouping frames in a physical layer, and the frames being respectively transmitted to a plurality of user terminals included in a single group; and
a communication unit to communicate with the communication apparatus using the group frame,
wherein the group frame comprises a first data field applied to all of the plurality of user terminals, and a second data field applied to each of the plurality of user terminals.

7. The user terminal of claim 6, wherein the first data field comprises:
group information comprising at least one of identification information indicating whether a received frame is the group frame, a number of the plurality of user terminals included in the group, and length information of the group frame; and
user information comprising at least one of length information and a modulation and coding scheme (MCS) of original data of each of the plurality of user terminals.

8. The user terminal of claim 6, wherein the second data field comprises:
control information regarding a transmission channel of the group frame for each of the plurality of user terminals; and
original data to be transmitted to each of the plurality of user terminals.

9. The user terminal of claim 6, wherein control information associated with a user device corresponding to first transmitted original data among original data included in the group frame is excluded from the second data field.

10. The user terminal of claim 6, wherein the receiver receives the first data field, and resumes receiving of the second data field after interruption of receiving for a period of time based on user information of another user terminal included in the first data field.

11. A method of transmitting a group frame, the method comprising:
generating a group frame by grouping frames in a physical layer, the frames being respectively transmitted to a plurality of user terminals included in a single group; and
transmitting the group frame to each of the plurality of user terminals,
wherein the group frame comprises a first data field applied to all of the plurality of user terminals, and a second data field applied to each of the plurality of user terminals.

12. The method of claim 11, wherein the first data field comprises:
group information comprising at least one of identification information indicating whether a received frame is the group frame, a number of the plurality of user terminals included in the group, and length information of the group frame; and
user information comprising at least one of length information and a modulation and coding scheme (MCS) of original data of each of the plurality of user terminals.

13. The method of claim 12, wherein the group information is arranged in an order of original data included in the second data field.

14. The method of claim 11, wherein the second data field comprises:
control information regarding a transmission channel of the group frame for each of the plurality of user terminals; and
original data to be transmitted to each of the plurality of user terminals.

15. The method of claim 11, wherein control information associated with a user device corresponding to first transmitted original data among original data included in the group frame is excluded from the second data field.

16. A method of receiving a group frame, the method comprising:
receiving a group frame from a communication apparatus, the group frame being generated by grouping frames in a physical layer, and the frames being respectively transmitted to a plurality of user terminals included in a single group; and
communicating with the communication apparatus using the group frame,
wherein the group frame comprises a first data field applied to all of the plurality of user terminals, and a second data field applied to each of the plurality of user terminals.

17. The method of claim 16, wherein the first data field comprises:
group information comprising at least one of identification information indicating whether a received frame is the group frame, a number of the plurality of user terminals included in the group, and length information of the group frame; and
user information comprising at least one of length information and a modulation and coding scheme (MCS) of original data of each of the plurality of user terminals.

18. The method of claim 16, wherein the second data field comprises:
control information regarding a transmission channel of the group frame for each of the plurality of user terminals; and
original data to be transmitted to each of the plurality of user terminals.

19. The method of claim 16, wherein control information associated with a user device corresponding to first transmitted original data among original data included in the group frame is excluded from the second data field.

20. The method of claim 16, wherein the receiving comprises receiving the first data field, and resuming receiving of the second data field after interruption of receiving for a period of time based on user information of another user terminal included in the first data field.
